(19) United States
(12) Patent Application Publication
(10) Pub. No.: US 2023/0331914 A1
(43) Pub. Date: Oct. 19, 2023

(54) POLYHYDROXYURETHANES AND METHODS OF THEIR MAKING AND USE

(71) Applicant: RockyTech, Ltd., Boulder, CO (US)

(72) Inventors: Yinghua JIN, Boulder, CO (US); Yiming HU, Boulder, CO (US); Haoying YU, Boulder, CO (US)

(21) Appl. No.: 18/100,477

(22) Filed: Jan. 23, 2023

Related U.S. Application Data
(60) Provisional application No. 63/322,758, filed on Mar. 23, 2022.

(51) Int. Cl. C08G 71/04; C08K 3/04; C08K 7/06

(52) U.S. Cl. CPC C08G 71/04; C08K 3/04; C08K 7/06

(57) ABSTRACT

A method for synthesizing polyhydroxyurethane polymers by using cyclic carbonates, amines, and base catalysts. A method for synthesizing polyhydroxyurethane (PHU) and polyimine (PI) hybrid polymer (PHU-PI) by using a multivalent cyclic carbonate monomer, a multivalent aldehyde monomer, and a multivalent amine monomer. A method for synthesizing a polyhydroxyurethane (PHU), polyimine (PI), and epoxy resin hybrid polymer (PHU-PI-epoxy) by using a multivalent cyclic carbonate monomer, a multivalent aldehyde monomer, a multivalent epoxide monomer, and a multivalent amine monomer. Cyclic carbonate monomers may be obtained from epoxides through the insertion of carbon dioxide. A polyhydroxyurethane may be reprocessed multiple times with minimal properties decrease with or without the addition of a catalyst. A polyhydroxyurethane may be combined with pristine or recycled reinforcing fibers to form a fiber-reinforced composite having specific desired material properties. Polyhydroxyurethanes and their composites may be recycled and reused.

### RELATED APPLICATION

This application claims priority to U.S. Provisional Application 63/322,758 filed on Mar. 23, 2022, the content of which is incorporated herein by reference in its entireties for all purposes.

### STATEMENT REGARDING FEDERALLY FUNDED RESEARCH

This invention was made with government support under Grant No. DE-SC0021869 awarded by Department of Energy. The government has certain rights in the invention.

### BACKGROUND

Carbon dioxide (CO₂) is the primary greenhouse gas produced by the consumption of fossil fuels and other human activities. Billions of tons of CO₂ removed from the atmosphere can be used as a feedstock to produce plastics.

Although the chemical fixation approach of converting CO₂ into valuable chemicals alone cannot have a major impact on decreasing the atmospheric CO₂ level, it has been considered a viable and attractive way to chemically capture and recycle CO₂.

The conversion of CO₂ into recyclable plastics could contribute to CO₂ sequestration and accelerate the transition from current fossil-fuel-based plastic materials to future generations of more sustainable materials.

Polyurethanes (PUs) are the most extensively used plastic materials with an annual production of nearly 24 million metric tons in 2020, accounting for about 7% by weight of all plastic production. PUs exist in both thermoplastic and thermoset forms and have been used in a broad range of end-user applications, such as heat-preservation foams, adhesives, architectural coatings, packages, and medical devices. However, their production has heavily relied on phosgene-derived isocyanate. Because of the high toxicity of chemicals used in the production, the growing demand for PUs has raised serious health and environmental concerns. About half of PUs production volume are cross-linked thermosets with permanently fixed topology, which cannot be reprocessed and repaired. As a result, a large amount of hard-to-recycle PUs including post-consumer products as well as scraps from postproduction products ends up in landfills, which reaches almost 10% of the total PUs production.

Polyhydroxyurethanes (PHUs) are non-isocyanate PU derivatives, which can be prepared from less toxic and more environmentally friendly cyclic carbonates. Unlike PUs, PHUs do not have biuret and allophanate defects and contain free hydroxyl groups that can form intra- and intermolecular hydrogen bonding. Therefore, PHUs generally exhibit higher thermal stability, chemical resistance, and enhanced adhesion and wear resistance than traditional PUs.

Cyclic carbonates, the starting material of PHUs can be formed through cycloaddition of CO₂ to epoxides, a convenient and efficient chemical fixation method of CO₂. Such reaction has many advantages, including, for example: (1) CO₂ is used directly as an abundant, cheap, and renewable C1 feedstock, and the process does not involve the energy-intensive reduction of CO₂; (2) The process is 100% atom economic (3) The reaction can be solvent-free; (4) The reaction is thermodynamically favored because the high free energy of epoxides counterbalances the high thermodynamic stability of carbon dioxide.

The development of PHUs has been mainly limited to thermoplastic forms which have low molecular weight and inferior mechanical properties. The thermoset forms of reprocessible and recyclable PHUs are rarely found.

### SUMMARY

The present disclosure provides methods for making and using PHUs and composite materials that incorporate PHUs. These polymers and composite materials are moldable and reshapable and recyclable.

In an embodiment, PHUs are polymers containing hydroxyurethane bonds formed from the reaction between cyclic carbonate monomers and amine monomers. In one aspect, the molar ratio of hydroxyurethane connections is higher than 50% among all the connections between monomers. In another aspect, the molar ratio of hydroxyurethane connections is higher than 60%, or 70% among all the connections between monomers.

In an embodiment, PHUs are prepared from at least one multivalent cyclic carbonate and at least one multivalent diamine monomer in amounts such that the molar equivalent ratio betweeb total cyclic carbonate groups and total amine groups in the reaction system is about 1:1, i.e., cyclic carbonate : amine - 1:1.

In another embodiment, the PHU includes a multivalent cyclic carbonate or a multivalent amine monomer as a cross-linking agent.

According to certain embodiments of the disclosure, multivalent cyclic carbonate monomers may be prepared through the [3+2] CO₂ insertion into the corresponding epoxy precursors (FIGS. 1A, 3A, 3B) at an elevated temperature in the presence of a catalyst. Various metal complexes, metal halides, ionic liquids, ammonium, or phosphonium salts may be used as the catalysts. Examples of the catalysts include, but are not limited to, tetrapropylammonium bromide (TPAB), Ti(OⁱPr)₄, 1,8-diazabicyclo[5.4.0]undec-7-ene (DBU and I₂), and tetrabutylammonium iodide (TBAI).

In some embodiments, simple and inexpensive aliphatic- or aromatic-based epoxides with different reactivities, flexibilities, and steric effects may be converted to cyclic carbonates. Examples of epoxides include, but are not limited to, diglycidyl ether of bisphenol A (DGEBA), 4,4′-Methylenebis(N,N-diglycidylaniline) (TGMDA), biocompatible glycol diglycidyl ethers (PEGDE), epoxidized plant oils, such as epoxidized soybean oils (ESBO), and limonene dioxide (LEP) (FIG. 2A).

In one embodiment, a method of converting DGEBA into the corresponding cyclic carbonate (DGEBA-CO₂) is provided using the combination of tetrapropylammonium bromide (TPAB) and Ti(OiPr)₄ as the catalyst system at elevated temperatures (80-150° C.). The quantitative yield (95 -100 %) of a cyclic carbonate may be obtained under optimum CO₂ pressure (e.g., 100-700 Psi, or 200-600 Psi, or 300-500 Psi) and a reaction temperature 80-150° C., or 80-140° C., 100-150° C., or 80-120° C.

In one aspect, the invention provides a polymerization method of cyclic carbonates through aminolysis at elevated temperatures (80-150° C.) (FIG. 1A). Examples of amines that can react with cyclic carbonates include, but are not limited to, hydrazine, diethylenetriamine (DETA), isophorone diamine (IPDA), tris(2-aminoethyl)amine (TREN), 4,4′ -oxydianiline (ODA), and Priamine, a 100% bio-based diamine, and bis(3-aminopropyl) terminated poly(dimethylsiloxane) (MW 500-8000) (FIG. 2B).

In some embodiment, common side reactions, such as amine carbonation, urea formation, amidation reaction, or oxazolidinone synthesis may be prevented at a reaction temperature below 130° C. Catalysts, solvents, temperature, reaction time, and stoichiometric ratio of cyclic carbonates and amines are important factors to promote polymerization and reduce side reactions. Solvent-free polymerization or melt-phase reactive extrusion in a twinscrew compounding machine may be possible.

In one embodiment, the invention relates to integration of epoxy resin to tune the properties of PHUs. The molar ratio between epoxide groups and cyclic carbonate groups in the monomer mixture may be in the range of 1%-30%, or 5-25%, or 10-20%.

In one embodiment, the invention relates to the integration of reversible imine bonds as additional dynamic covalent linkages to enhance the reprocessibility of PHUs at a relatively low temperature (e.g., 80-140° C., or 90-130° C., or 100-130° C., or 80-120° C.). The molar ratio between imine bonds and carbamate bonds may be in the range of (1%-30%), or 5-25%, or 10-20%.

In an aspect, a method for preparing the PHU polymers comprises the following steps: a) combining a melted mixture of at least one multivalent cyclic carbonate monomer and at least one multivalent amine monomer in the presence or absence of a solvent and a base catalyst; b) heating the mixture of step a) to a temperature between 80-250° C. until all the volatiles evaporate and polymerization completes; c) allowing the polymer of step b) to cool to a temperature around 20-25° C.

In an aspect, a method for preparing the PHU containing dynamic imine bonds comprises the following steps: a) combining a melted mixture of at least one multivalent cyclic carbonate monomer and at least one multivalent aldehyde monomer, and at least one multivalent amine monomer in the presence or absence of a solvent and a base catalyst; b) heating the mixture of step a) to a temperature between 80-250° C. until all the volatiles evaporate and polymerization completes; c) allowing the polymer of step b) to cool to a temperature around 20-25° C.

In another aspect, a method for preparing the PHU polymers containing epoxy resins comprises the following steps: a) combining a melted mixture of at least one multivalent cyclic carbonate monomer, at least one multivalent epoxide monomer, at least one multivalent aldehyde monomer, and at least one multivalent amine monomer in the presence or absence of a solvent and a base catalyst; b) heating the mixture of step a) to a temperature between 80-250° C. until all the volatiles evaporate and polymerization completes; c) allowing the polymer of step b) to cool to a temperature around 20-25° C.

In some embodiments, the invention relates to reversible transcarbamoylation (FIG. 1B), which occurs through the exchange of carbamate groups and free pendant hydroxyl groups in the absence or presence of a base catalyst at elevated temperatures. Examples of the base catalyst include, but are not limited to, triazabicyclodecene (TBD) or 4-dimethylaminopyridine (DMAP). In one aspect, the disclosed PHUs contain both free hydroxyl groups and urethane linkages and undergo transcarbamoylation, leading to their malleability and reprocessibility.

In one aspect, the invention relates to the malleability and reprocessibility of PHUs. When heat and pressure are applied to PHUs, PHUs may undergo reversible transcarbamoylation to adapt to the external stimuli (heat and pressure here) by releasing the stress. Therefore, cross-linked PHUs may be reprocessible and reshapable when the reversibility of transcarbamoylation is activated at an elevated temperature of 200° C.-270° C., or 220° C.-260° C., or 230° C.-250° C.

In one embodiment, the invention relates to the integration of epoxy resin to improve the mechanical properties of PHUs. The molar ratio of epoxide groups and cyclic carbonate groups in the monomer mixture may be in the range of 1%-10%, or 3-8%, or 4-6%.

In one embodiment, the invention relates to the integration of reversible imine bonds as additional dynamic covalent linkages to enhance the reprocessibility of PHUs at a relatively low temperature, for example, 80-140° C., or 90-130° C., or 100-130° C., or 80-120° C. The molar ratio of imine bonds and carbamate bonds may be in the range of 1%-10%, or 3-8%, or 4-6%.

In an aspect, a PHU polymer can be reprocessed at least once through transitioning between a non-malleable state and a malleable state and between a malleable state and a non-malleable state upon exposure to a range of temperatures wherein the rate of transcarbamoylation imparts a malleable state to the polymer, and wherein the PHU polymer comprises a base catalyst wherein the catalyst results in a decrease in the transition temperature relative to the PHU polymer without the catalyst. In another aspect, the transition temperature is from about 80° C. to about 250° C., or 120° C. to 200° C., or 150° C. to about 180° C.

In one aspect, the invention provides recycling of the PHUs through depolymerization (FIG. 1C). The depolymerization process includes, a) contacting a PHU polymer with a liquid including at least a molecule that has a primary hydroxy or amine moiety in the presence or absence of a base; and b) allowing the polymer to substantially dissolve in the liquid of step a.) to form a polymer solution; and c) Using the polymer solution from step b) to prepare PHU polymers.

In another aspect, recycling steps of the PHUs through depolymerization include a.) contacting a PHU polymer with a liquid including at least a molecule that has a primary hydroxy or amine moiety in the presence or absence of a base; and b) allowing the polymer to completely dissolve and be converted to small molecules in the liquid of step a); and c) Purification of the small molecules in step b) to obtain pure small-molecule chemicals. The small-molecule chemicals can be used for making other materials.

In another aspect, crosslinked PHUs may be combined with various forms of reinforcing additives. The reinforcing additives include talc, clay, carbon fibers (pristine, recycled, woven, chopped, or milled), natural fibers (hemp, flex etc.), graphene, carbon blacks, glass fibers, or other additives for example flame retardants, surface modifiers, dyes, pigments, and mold releasing agents. The amount of reinforcing additives may be 5-70% and the amount of other additives may preferably <5%.

In an aspect, a method for preparing a composite material includes: a) soaking the reinforcing additives in a melted mixture of at least one multivalent cyclic carbonate monomer, and at least one multivalent amine monomer in the presence or absence of a base catalyst; b) heating the mixture of step a) to a temperature between 80-250° C. until polymerization completes; c) pressing the heated composites of step b) into a mold; and d) allowing the heated composites of step c) to cool to a temperature below the transitional temperature.

In an aspect, a method for preparing a composite material includes: a) soaking the reinforcing additives in a melted mixture of at least one multivalent cyclic carbonate monomer, at least on multivalent aldehyde monomer, and at least one multivalent amine monomer in the presence or absence of a base catalyst; b) heating the mixture of step a) to a temperature between 80-250° C. until polymerization completes; c) pressing the heated composites of step b) into a mold; and d) allowing the heated composites of step c) to cool to a temperature below the transitional temperature.

In an aspect, a method for preparing a composite material includes: a) soaking the fibrous or non-fibrous filler material in a solution of a mixture of at least one multivalent cyclic carbonate monomer and at least one multivalent amine monomer in a solvent in the presence or absence of a base catalyst; b) heating the mixture of step a.) to a temperature between 80-250° C. until all the volatiles evaporate and the polymerization completes; c) pressing the heated composites of step b) into a mold; and d) allowing the heated composites of step c) to cool to a temperature below the transitional temperature.

In an aspect, a method for preparing a composite material includes: a) soaking the fibrous or non-fibrous filler material in a solution of a mixture of at least one multivalent cyclic carbonate monomer, at least one multivalent aldehyde monomer, and at least one multivalent amine monomer in a solvent in the presence or absence of a base catalyst; b) heating the mixture of step a) to a temperature between 80-250° C. until all the volatiles evaporate and the polymerization completes; c) pressing the heated composites of step b) into a mold; and d) allowing the heated composites of step c) to cool to a temperature below the transitional temperature.

In one aspect, the invention relates to the processing of fiber-reinforced composites (FRCs) sheets that are made using PHUs and fibers through a heat press. The steps include a) Heating of FRC sheets above the transition temperature between malleable state and non-malleable state; b) pressing the sheets onto a rigid die to make composite sheets conform to the die; c) Allowing the composite material to cool below the transition temperature. Complete stress relaxation in the PHU matrix would cause FRC sheets to retain the deformed shape even after the compression is removed.

In an aspect, a PHU composite can be reprocessed at least one time through transitioning between a non-malleable state and a malleable state and between a malleable state and a non-malleable state upon exposure to a range of temperatures wherein the rate of transcarbamoylation imparts a malleable state to the polymer, and wherein the PHU polymer could comprise a base catalyst wherein the catalyst results in a decrease in the transition temperature relative to the PHU polymer without the catalyst. In one aspect, the transition temperature is from about 80° C. to about 250° C.

In an aspect, the invention provides a recycling method of the composite material, which includes, a) contacting the composite material with a liquid including at least a molecule that has a primary hydroxy moiety in the presence or absence of a base; and b) allowing the composite material to substantially dissolve in the liquid of step a); and c) separating the resulting solution from a fibrous or non-fibrous filler material; and d) using the polymer solution from step c) to prepare PHU polymers; and e) using filler materials from step c) to prepare composite materials.

In another aspect, the invention provides a recycling method of the composite material, which includes, a) contacting the composite material with a liquid including at least a molecule that has a primary hydroxy or amine moiety in the presence or absence of a base; and b) allowing the composite material to substantially dissolve in the liquid of step a); and c) separating the resulting solution from a fibrous or non-fibrous filler materials; and d) purifying the solution from step c) to obtain small molecule chemicals; and e) using filler materials from step c) to prepare composite materials.

The above embodiments may provide high-performance recyclable and malleable PHU thermosets from cheap monomers prepared using CO₂. The PHU thermosets would be stable under various harsh conditions including acid exposure. The presence of inherent hydroxyl groups could enable dynamic bond exchange via transcarbamoylation and impart unique characteristics to the cross-linked PHUs, including malleability, reprocessibility, and recyclability. They could be fully decomposed into monomers or other value-added small molecules through depolymerization, enabling the recycling or upcycling of all the chemicals.

The above embodiments may provide solvent-free synthesis of cyclic carbonates and their polymerization that can be easily scaled up on an industrial scale. Depending on the monomer structures, PHUs with rubbery elastomeric, or thermoplastic-like properties, which may be suitable as 3D printing materials, or thermoset-like plastics, which may have comparable mechanical properties to the commonly used epoxy thermosets.

The above embodiments may provide recyclable and conductive FRCs when carbon fibers and conductive fillers, for example, conductive carbon black or graphenes are used as reinforcing additives and PHUs are used as matrices.

Features and steps from any of the disclosed embodiments may be used in combination with one another, without limitation. For example, any of the compositional limitations described with respect to one embodiment may be present in any of the other described embodiments. In addition, other features and advantages of the present disclosure will become apparent to those of ordinary skill in the art through consideration of the following detailed description and the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A shows the schematic of polyhydroxyurethane formation process from epoxides through CO₂ addition to form cyclic carbonates and subsequent aminolysis to form polyhydroxyurethane.

FIG. 1B shows the schematic of transcarbamoylation dynamic exchange process.

FIG. 1C shows the schematic of PHU degradation process through transcarbamoylation in an alcohol.

FIG. 1D shows the compositions of various PHUs containing hydroxyurethane bonds, imine bonds, and —N—CH₂—C(OH)— bonds.

FIGS. 2A and 2B show examples of structures of epoxides and amines that could be used in the cyclic carbonate formation and PHU polymer formation.

FIG. 3A shows the synthesis of PHU containing polymers (PHU, PHU-PI, and PHU-PI-epoxy) from DGEBA-CO₂. DGEBA-CO₂ can be synthesized from DGEBA through CO₂ insertion under the combined catalyst of Ti(OiPr)₄ and TPAB.

FIG. 3B shows the Nuclear Magnetic Resonance (NMR) Spectra of DGEBA and the crude product (DGEBA-CO₂) obtained after CO₂ insertion into DGEBA.

FIG. 3C shows a representative tensile stress-strain curve of a PHU polymer containing approximately 10 mol% imine bonds.

FIG. 4 shows the schematic of the degradation of the cross-linked PHU made from DGEBA-CO₂ and TREN. The PHU can be degraded after soaking in EtOH at 100° C. for 8 h with agitation in the presence of K₂CO₃. The degradation products are DGEBA-4OH and 3Cbm-TREN. 3Cbm-TREN can be further converted to 3Me-TREN.

FIG. 5A shows the schematic of the PHU-based carbon fiber-reinforced composite (PHU-CFRC) formation through in situ polymerization of DGEBA-CO₂ and TREN in the presence of a piece of woven carbon fiber sheet. The optical image of the carbon fiber composite is also shown.

FIG. 5B shows the reshaping of PHU-CFRC through the application of simple heating and external force.

FIG. 5C shows the recycling of PHU-CFRC in ethanol. Non-damaged carbon fiber can be retrieved from the degradation solution.

FIG. 6 shows the fabrication of conductive carbon fiber reinforced composites (CFRCs) using recycled milled carbon fibers and conductive carbon black (super C45).

The drawings are included to provide a better understanding of the invention and are not intended to be limiting in scope, but to provide exemplary illustrations.

### DETAILED DESCRIPTION OF VARIOUS EMBODIMENTS

It is to be understood that the disclosure is not limited to the specific embodiments and methods described below, as specific components and/or conditions may vary. Furthermore, the terminology used herein is used only for the purpose of describing particular embodiments and is not intended to be limiting in any way.

Except in the examples, or where otherwise expressly indicated, all numerical quantities in this description indicating amounts of material or conditions of reaction and/or use are to be understood as modified by the word “about” in describing the broadest scope of the disclosure. Also, unless expressly stated to the contrary: description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation; and, unless expressly stated to the contrary, measurement of a property is determined by the same technique as previously or later referenced for the same property.

It must also be noted that, as used in the specification and the appended claims, the singular form “a,” “an,” and “the” may comprise plural references unless the context clearly indicates otherwise. For example, reference to a component in the singular is intended to comprise a plurality of components.

Unless defined otherwise, all technical and scientific terms used herein generally have the same meaning as commonly understood by one of ordinary skill in the art to which this disclosure belongs. Generally, the nomenclature used herein and the laboratory procedures in organic chemistry, and polymer chemistry are those well-known and commonly employed in the art.

As used herein, the term “polymerization” or “cross-link” refers to at least one reaction that consumes at least one functional group in a monomeric molecule (or monomer), oligomeric molecule (or oligomer) or polymeric molecule (or polymer), to create at least one chemical linkage between at least two distinct molecules (e.g., intermolecular bond), at least one chemical linkage within the same molecule (e.g., intramolecular bond), or any combinations thereof. A polymerization or cross-linking reaction may consume between about 0% and about 100% of the at least one functional group available in the system. In an embodiment, polymerization or cross-linking of at least one functional group results in about 100% consumption of the at least one functional group. In another embodiment, polymerization or cross-linking of at least one functional group results in less than about 100% consumption of the at least one functional group.

As used herein, the term “elevated temperature” refers to a temperature that is higher than room temperature (room temperature is typically at 20-25° C.).

The catalysts for CO₂ insertion into epoxides to form cyclic carbonates are disclosed herein. The wide variety of multivalent cyclic carbonates may be prepared from epoxides through CO₂ insertion. By way of examples, examples of the catalysts may include but not limited to the combination of Ti(OiPr)₄ and tetrapropylammonium bromide, or the combination of Ti(OiPr)₄ and tetrabutylammonium bromide.

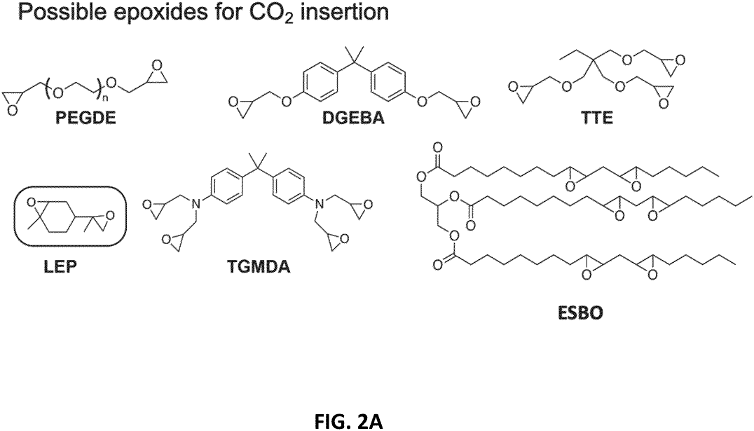

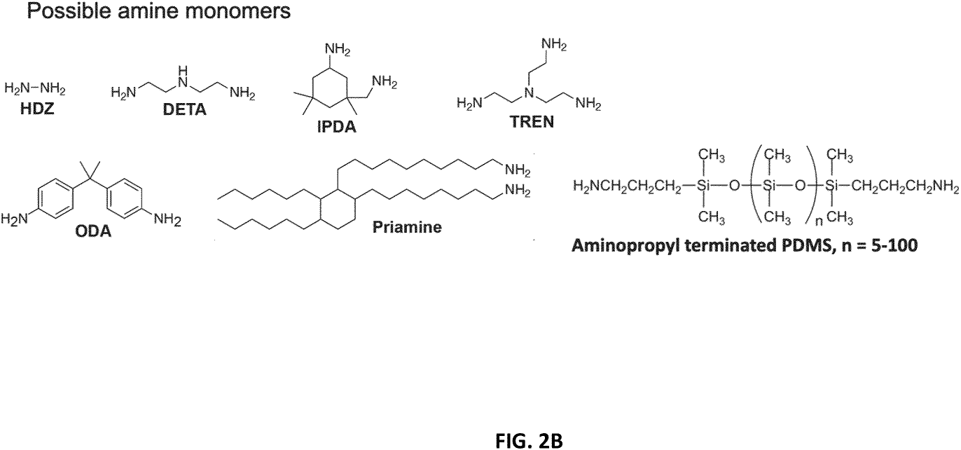

Compositions comprising PHUs are disclosed herein. In an embodiment, the PHU may be prepared from a divalent cyclic carbonate monomer, a diamine monomer, and a multivalent cross-linking agent. The cross-linking agent comprises a multivalent cyclic carbonate monomer, multivalent aldehyde monomer, or a multivalent amine monomer. Many diamines and triamines are readily available, which makes PHUs an accessible class of polymer to synthesize. A non-limiting representation of epoxide precursors and amine monomers that can be used to make PHUs of the present disclosure is represented in FIGS. 2A-2B.

In one embodiment, the preparation of linear PHU comprises the combination of a divalent cyclic carbonate and a diamine monomer of appropriate geometries. In a non-limiting aspect, preparation of a cross-linked PHU further comprises the use of a tri, tetra or multivalent cyclic carbonate monomer, or a tri, tetra or multivalent amine monomer.

In one embodiment, the preparation of crosslinked PHU comprises the combination of a divalent cyclic carbonate and a divalent aldehyde monomer, and a diamine monomer of appropriate geometries. In a non-limiting aspect, preparation of such a cross-linked PHU (PHU-PI) further comprises the use of a tri, tetra or multivalent cyclic carbonate monomer, a tri, tetra or multivalent aldehyde monomer, or a tri, tetra or multivalent amine monomer.

In one embodiment, the preparation of crosslinked PHU comprises the combination of a divalent cyclic carbonate, a divalent aldehyde monomer, a divalent epoxide monomer, and a diamine monomer of appropriate geometries. In a non-limiting aspect, preparation of such a cross-linked PHU (PHU-PI-epoxy) further comprises the use of a tri, tetra or multivalent cyclic carbonate monomer, a tri, tetra or multivalent aldehyde monomer, a tri, tetra or multivalent epoxide monomer, or a tri, tetra or multivalent amine monomer.

In certain embodiments, preparation of the PHUs of the disclosure further require at least one catalyst, wherein the catalyst may be a base or a nucleophile. In other embodiments, at least one catalyst catalyzes the formation of the urethane groups.

Methods of preparing PHUs as disclosed herein include, but are not limited to, the following embodiments. In an embodiment, the method comprises the steps of contacting at least one multivalent cyclic carbonate monomer and at least one multivalent amine monomer in a solvent and converting the resulting material into the dry form of PHUs, whereby the composition comprising the PHU polymer is prepared. In another embodiment, the method comprises the steps of heating the melted mixture of at least one multivalent cyclic carbonate monomer and at least one multivalent amine monomer at an elevated temperature and cooling the resulting material to room temperature. In yet another embodiment, a method of reprocessing or repurposing a PHU polymer is disclosed.

In an embodiment, the method comprises the steps of contacting at least one multivalent cyclic carbonate monomer, at least one multivalent aldehyde monomer, and at least one multivalent amine monomer in a solvent and converting the resulting material into the dry form of PHU-PIs, whereby the composition comprising the PHU-PI polymers linked by hydroxyurethane bonds and imine bonds is prepared. In another embodiment, the method comprises the steps of heating the melted mixture of at least one multivalent cyclic carbonate monomer, at least one multivalent aldehyde monomer, and at least one multivalent amine monomer at an elevated temperature and cooling the resulting material to room temperature. In yet another embodiment, a method of reprocessing or repurposing a PHU-PI polymer is disclosed.

In an embodiment, the method comprises the steps of contacting at least one multivalent cyclic carbonate monomer, at least one multivalent aldehyde monomer, at least one multivalent epoxide monomer, and at least one multivalent amine monomer in a solvent and converting the resulting material into the dry form of PHUs, whereby the composition comprising the PHU-PI-epoxy polymers linked by hydroxyurethane bonds, imine bonds, and —C—N—CH₂—C(OH)— is prepared. In another embodiment, the method comprises the steps of heating the melted mixture of at least one multivalent cyclic carbonate monomer, at least one multivalent epoxide monomer, at least one multivalent aldehyde monomer, and at least one multivalent amine monomer at an elevated temperature and cooling the resulting material to room temperature. In yet another embodiment, a method of reprocessing or repurposing a PHU-PI-epoxy polymer is disclosed.

In an embodiment, cross-linked PHUs (PHU, PHU-PI, PHU-PI-epoxy) may be used as the binder/resin for advanced composite materials such as talc, clay, carbon fibers (pristine, recycled, woven, chopped, or milled), and natural fibers (hemp, flex etc.), graphene, carbon blacks, carbon nanotubes, glass fibers, and common and uncommon fibrous composites. Such PHU composites are thermomoldable, reprocessible, and recyclable. In an embodiment, conductive composite materials may be prepared by using the combination of carbon fibers and conductive nano fillers such as carbon black and graphene derivatives as fillers in a PHU matrix.

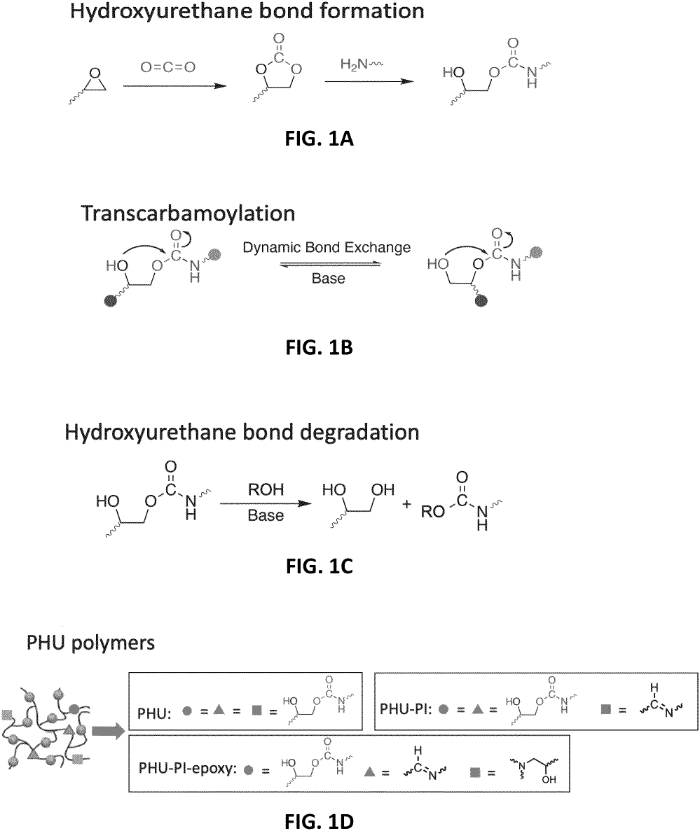

Referring now to FIG. 1A, a method of forming PHUs according to an embodiment of the disclosure is shown schematically. The method may include the formation of cyclic carbonates from epoxides and the aminolysis of cyclic carbonates. Hydroxyurethane linkages would be formed. An elevated temperature and a base catalyst may be applied to expedite the hydroxyurethane formation and thus the polymerization process. The method provides the incorporation of CO₂ into PHUs, providing a green and sustainable approach to form PHUs.

Referring now to FIG. 1B, transcarbamoylation between a free hydroxy group and a carbamate group is one of the mechanisms that enables the transition of a PHU between a malleable state to a non-malleable state as well as the recyclability of a PHU. A PHU inherently has free hydroxy groups and carbamates in the polymer chain thus can undergo transcarbamoylation. The kinetic of transcarbamoylation can be tuned through the addition of a base catalyst, for example, TBD or DMAP, or the application of heat. Transcarbamoylation can occur within the same polymer chains as well as between different polymer chains.

Referring now to FIG. 1C, in the presence of excess of a mono alcohol component, the equilibrium shifts toward depolymerization, leading to the cleavage of polymer chains and formation of soluble oligomers or even monomer derivatives, for example, multi-ols and multivalent carbamates. The depolymerization of PHUs allows complete recovery of all the chemical compositions.

Referring now to FIG. 1D, imine bonds can be incorporated in PHUs to form PHU-PI hybrid by adding at least one multivalent aldehyde monomer in combination with at least one multivalent cyclic carbonate monomer to enable the malleability of PHU at a lower temperature 80-140° C. To tune the mechanical properties of PHUs, multivalent epoxide monomers can also be combined with at least one multivalent aldehyde monomer and at least one multivalent cyclic carbonate monomer to form PHU-PI-epoxy hybrid containing hydroxyurethane bonds, imine bonds and —C—N—CH₂—C(OH)— bonds.

Referring now to FIG. 2A, examples of epoxides that can be converted into cyclic carbonate monomers through CO₂ fixation include, but are not limited to, diglycidyl ether of bisphenol A (DGEBA), 4,4′-Methylenebis(N,N-diglycidylaniline) (TGMDA), trimethylolpropane triglycidyl ether (TTE), biocompatible glycol diglycidyl ethers (PEGDE), epoxidized soybean oils (ESBO), and limonene dioxide (LEP).

Referring now to FIG. 2B, examples of amines that can be used to polymerize multivalent cyclic carbonates through aminolysis include, but are not limited to, hydrazine, diethylenetriamine (DETA), isophorone diamine (IPDA), tris(2-aminoethyl)amine (TREN), 4,4′ -oxydianiline (ODA), and Priamine, a 100% bio-based diamine, and aminopropyl terminated polydimethylsiloxane (Mw = 150-30,000) (FIG. 2B).

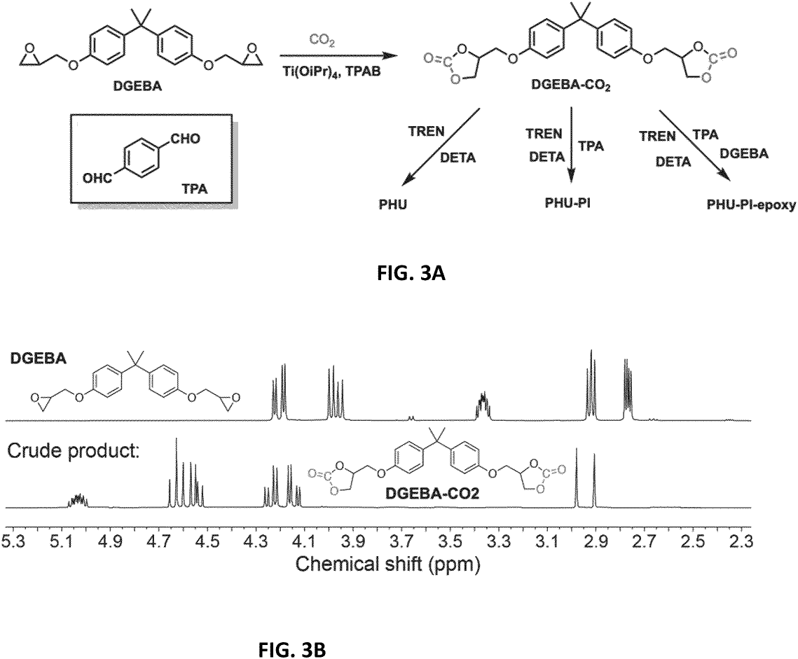

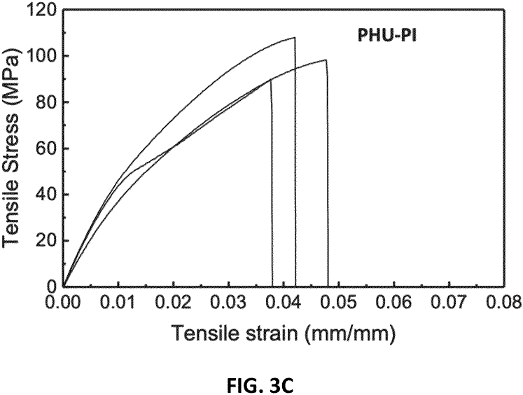

As illustrated in FIG. 3A, the epoxide DGEBA could be converted to DGEBA-CO₂ through the reaction with CO₂. The combination of tetrapropyl ammonium bromide (TPAB) and Ti(OiPr)₄ could be used as a catalyst system. The product could be characterized by ¹H NMR spectroscopy. The comparison of ¹H NMR spectra of DGEBA and crude DGEBA-CO₂ product show the high purity of the crude product even without the purification process.

In another embodiment, a PHU, PHU-PI, or PHU-PI-epoxy film was prepared by predissolving the monomers in dimethylforamide (DMF) and adding the resulting solutions together in an open vessel at 120° C. in an oven. When DMF was evaporated, the polymer film was formed.

As shown in Table 1, a variety of PHU, PHU-PI, PHU-PI-epoxy polymers could be formed when a mixture of divalent DGEBA-CO₂ with various amount of terephaldehyde (TPA) and DGEBA with diamine, DETA or preamine, and triamine TREN in a solvent and the mixture was heated at 120° C. for 10-15 hours. The freshly prepared polymer film sample was heat-pressed at 120° C. for another 1-2 hours. After cooling to room temperature (20-25° C.), the film was characterized by a stress-strain experiment. The tensile moduli (Young’s moduli) of these PHU-related polymers were in the range of ~2.6-5.2 GPa. In an embodiment, the curve in FIG. 3C represents the typical stress-strain performance of the PHU-PI polymer: Young’s modulus ~4.5-4.9 GPa, stress at break ~90-108 MPa, elongation at break about 3-4%.

In an aspect, the chemical compositions, functional group contents, and free end groups of PHUs could be characterized by FTIR and NMR spectroscopy. The mechanical properties (tensile modulus, strength, and elongation) of PHUs could be evaluated by uniaxial tensile tests using Instron. The glass transition temperature of a PHU could be measured using Dynamical Mechanical Analysis (DMA). The activation temperature of transcarbamoylation could be determined through temperature-dependent stress-relaxation experiments. Bulk stress relaxation of a PHU under different temperatures could be measured using DMA. Thermal gravimetric analysis (TGA) could be performed to evaluate thermal stability. Swelling tests in various organic solvents and water could be performed to evaluate their chemical stability.

Transcarbamoylation occurs through the exchange of carbamate groups and free pendant hydroxyl groups in the absence or presence of a base. PHUs contain both free hydroxyl groups and hydroxyurethane linkages and therefore undergo transcarbamoylation, which attributes to their malleability and recyclability. The kinetics of the bond exchange is critical to achieving fast stress relaxation and short reprocessing time. The kinetic profile of transcarbamoylation and the possible side reactions could be evaluated using small molecule model compounds with various electronic and steric characteristics. Reaction conditions including catalyst and temperature would also play an important role in determining the kinetic relaxation behavior of PHUs. The malleability of PHUs is enabled at 80 -250° C.

In an embodiment, imine bonds can be incorporated into PHUs to form PHU and polyimine (PI) hybrid polymers (PHU-PI) by using at least one multivalent aldehyde monomers in combination with at least one multivalent cyclic carbonate monomers as the reactive counterparts of the amine monomers. When imine bonds are incorporated into PHUs, the malleability may be enabled at a much lower temperature (80-140° C.).

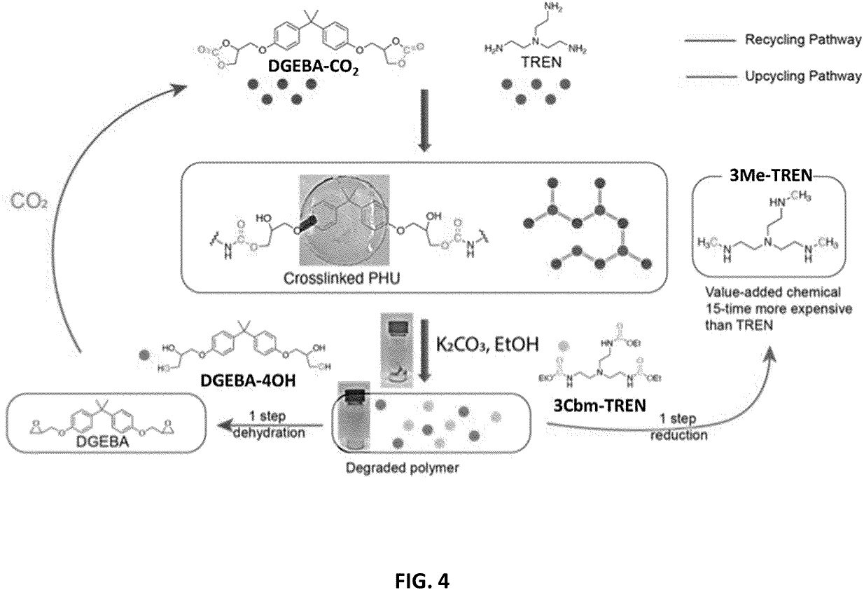

In an embodiment, PHU, PHU-PI, PHU-PI-epoxy and can be recycled where the products of the recycling process can be reused to make PHU, PHU-PI, PHU-PI-epoxy polymers with similar properties as the original polymers. In an embodiment, a PHU made from DGEBA-CO2 and TREN, as depicted in FIG. 4, was depolymerized in ethanol. Potassium carbonate (K₂CO₃) was added as a catalyst. The depolymerization occurs through transcarbamoylation between hydroxyurethane groups in the polymer chain and ethanol with a primary hydroxy group, which results in cleavage of polymer chains and a decrease of molecular weight. The PHU can be converted into soluble oligomers and further into small molecules, a multi-hydroxy compound, DGEBA-40H, and multivalent carbamates, 3Cbm-TREN. Transcarbamoylation between DGEBA-4OH and 3Cbm-TREN with the removal of ethanol can form the PHU with similar chemical compositions as the original PHU. DGEBA-4OH could also be converted into DGEBA through one-step dehydration. 3Cbm-TREN could be converted to 3Me-TREN through one-step reduction. These small molecules can be used as starting materials in the preparation of other materials.

In one embodiment, the invention provides the fabrication method of carbon fiber reinforced composites (CFRCs) made of cross-linked PHUs, PHU-PI, and PHU-PI-epoxy polymers. There are two fabrication methods for PHU-containing CFRCs: liquid-based and semi-solid-based. In the former method, liquid monomer combinations first infiltrate the carbon fibers and then get cured to form a solid composite material. In the latter method, fibers are first combined with cross-linked polymer resin to form a layer of fiber-matrix mixture, known as the “prepreg”. Because of the malleability of cross-linked PHUs, PHU-PI, and PHU-PI-epoxy polymers, CFRC prepregs made of PHUs, PHU-PI, and PHU-PI-epoxy polymers would have an infinite shelf life. The prepregs can be used later to form laminates with desired layups and geometry through vacuum bag molding or compression molding.

In another embodiment, these composite materials can be prepared in ratios ranging from 30:70 fiber:resin by weight to 70:30 fiber:resin by weight. In yet another embodiment, these materials can be prepared in ratios ranging from 10:90 fiber:resin by weight to 90:10 fiber:resin by weight.

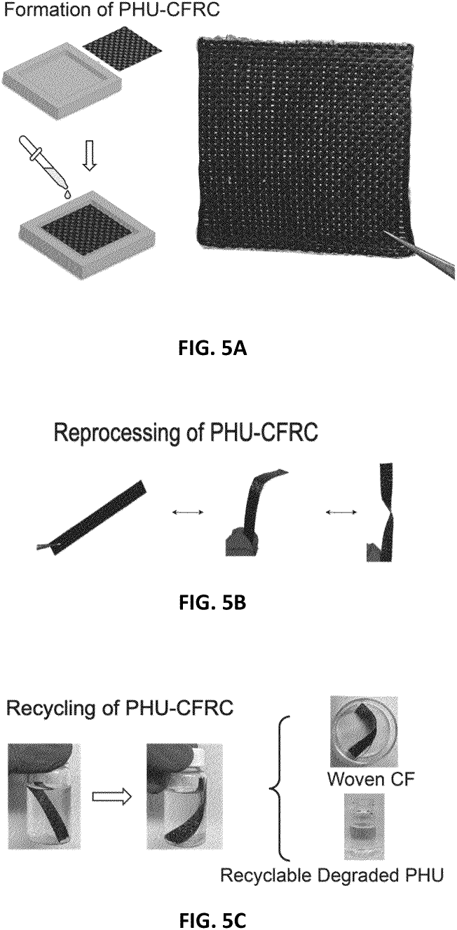

In an embodiment, the invention provides liquid-based fabrication method of CFRCs from DGEBA-CO₂ and TREN, as illustrated in FIG. 5A. A piece of woven carbon fiber was placed in a solution of DGEBA-CO₂ and TREN in DMF in an open vessel. The setup was placed at 100° C. in a fume hood. When DMF was evaporated, the single-ply composite was formed. In another aspect, a combination of milled recycled carbon fibers and conductive carbon black was used instead of a woven carbon fiber sheet. The resulting composites have conductivity in a range of 500 s/m to 3000 s/m.

According to some embodiments, the composites made of PHU, PHU-PI, and PHU-PI-epoxy polymers may be malleable and thermoformable, such that reprocessing of the composite is enabled. The composites in embodiments may be shaped by cutting, bending or other manipulation such that the composite takes on an appropriate shape for the intended use. The resulting shaped composite may then be heated at a temperature above the transition temperature within the range of 80° C. to 250° C., for a period of at least 3 min, or in the range of 1-4 hours. After cooling to a temperature below the transition temperature, the shape may be retained without the temporary reinforcement used in the shaping step. The thermoforming process can be repeated at least once. The composites may be shaped multiple times by repeating heating and cooling cycle, as depicted in FIG. 5B.

In an embodiment, the composites can be recycled in an efficient closed-loop process where the chemical components produced in the recycling process and fibers can be reused for their original purpose. In an embodiment, the composite made from a woven carbon fiber sheet and a PHU, PHU-PI, or PHU-PI-epoxy could be recycled by depolymerizing the PHU polymer. The depolymerization occurs mainly through transcarbamoylation between urethane groups in the polymer chain and an alcohol with primary hydroxy groups, which results in cleavage of polymer chains and decrease of molecular weight. The PHU can be converted into soluble oligomers and further into small molecules. These chemical products from the recycling process can be converted into PHUs, PHU-PI, or PHU-PI-epoxy or purified to become chemical feedstocks that can be used for other purposes. The woven carbon fiber can be retrieved from the recycling solution and reused to make composites.

In some embodiments, the disclosed PHU products (PHU, PHU-PI, or PHU-PI-epoxy) have at least some or all of the following advantages: (1) Unlike traditional polyurethanes (PUs), the production of these polymers does not rely on the isocyanate chemistry with high toxicity; (2) They have comparable or superior mechanical and thermal properties to traditional PU thermosets, but are reprocessible and recyclable; (3) When used as polymer matrices in fiber-reinforced composites, they can have comparable mechanical properties to common CFRCs made of a thermoset, but with excellent reprocessibility and full recyclability of all the chemical components and fibers. These advantages are achieved by the incorporation of dynamic hydroxyurethane crosslinks in the presence or absence of dynamic imine bonds, which can break and reform under applied stimuli (i.e., catalyst and temperature). The PHU-related products made from CO₂-derived monomers can reduce the carbon footprint and contribute to the “circular economy.”

The present disclosure may be further illustrated by the following Items:

Item 1: A composition comprising a polyhydroxyurethane (PHU) polymer prepared from a reaction system comprising a multivalent cyclic carbonate monomer and a multivalent amine monomer.

Item 2: The composition of Item 1, wherein the molar equivalent ratio of total cyclic carbonate groups and total amine groups in the reaction system is about 1:1.

Item 3: The composition of any preceding Items, further comprising at least one type of fiber.

Item 4: The composition of Item 3, wherein the at least one type of fiber is carbon fiber.

Item 5: A composite material comprising the composition of any preceding Items, wherein said composite material is prepared by curing the composition of of said preceding Items.

Item 6: The composition of any preceding Items wherein said polyhydroxyurethane polymer is not malleable in dry form at room temperature and said polyhydroxyurethane polymer becomes malleable when said it is in contact with a catalyst or when it is heated to a temperature between 70° C. and 250° C.

Item 7: A composition comprising a polyhydroxyurethane (PHU) and polyimine (PI) hybrid polymer (PHU-PI) prepared from a reaction system comprising a multivalent cyclic carbonate monomer, a multivalent aldehyde monomer, and a multivalent amine monomer.

Item 8: The composition of Item 7, wherein the molar equivalent ratio between total cyclic carbonate groups and aldehyde groups and total amine groups in the reaction system is about 1:1 ((cyclic carbonate + aldehyde):amine ~ 1:1).

Item 9: The composition of any one of Items 7-8, further comprising at least one type of fiber.

Item 10: The composition of Item 9, wherein the at least one type of fiber is carbon fiber.

Item 11: A composite material comprising the composition of any one of Items 9-10, wherein said composite material is prepared by curing the composition of any one of Items 9-10.

Item 12: The composition of any one of Items 7-11, wherein said polyhydroxyurethane (PHU) and polyimine (PI) hybrid polymer (PHU-PI) is not malleable in dry form at room temperature and said PHU-PI hybrid polymer becomes malleable when said it is in contact with a catalyst or when it is heated to a temperature between 70C and 250C.

Item 13: A composition comprising a polyhydroxyurethane (PHU), polyimine (PI), and epoxy resin hybrid polymer (PHU-PI-epoxy) prepared from a reaction system comprising a multivalent cyclic carbonate monomer, a multivalent aldehyde monomer, a multivalent epoxide monomer, and a multivalent amine monomer.

Item 14: The composition of Item 13, wherein the molar equivalent ratios between total cyclic carbonate groups, plus aldehyde groups, plus epoxide and total amine groups in the reaction system are about 1:1 ((cyclic carbonate+aldehyde+epoxide):amine ~ 1:1).

Item 15: The composition of any one of Items 13-14, further comprising at least one type of fiber.

Item 16: The composition of Item 15, wherein the at least one type of fiber is carbon fiber.

Item 17: A composite material comprising the composition of any one of Items 13-16, wherein said composite material is prepared by curing the composition of any one of Items 13-16.

Item 18: The composition of any one of Items 13-17, wherein said polyhydroxyurethane (PHU), polyimine (PI), and epoxy resin hybrid polymer (PHU-PI-epoxy) is not malleable in dry form at room temperature and said PHU-PI-epoxy hybrid polymer becomes malleable when said it is in contact with a catalyst or when it is heated to a temperature between 70° C. and 250° C.

Item 19: A method of reshaping the composition of any one of Items 1-18, comprising a) heating a sheet form of the composite material to an elevated temperature, b) pressing and material from step (a), and c) cooling the material from step (b) to room temperature.

Item 20: A method of recycling the composition of any one of Items 1-18, comprising a) contacting the polyhydroxyurethane polymer with a liquid to form a soluble material, and b) converting the soluble material into a dry form of the polyhydroxyurethane polymer, or the pure form of small molecules.

Item 21: A method of recycling the composition of any one of Items 1-18, comprising a) contacting the composition with a liquid to form a soluble material, b) separating at least one fiber from the soluble material, and c) converting the soluble material into a dry form of the polyhydroxyurethane polymer, or the pure form of small molecules.

Item 22: The composition of Item 5, wherein the weight ratio between the carbon fiber and the polymer is from 10:90 to 70:30.

Item 23: A process of preparing a multivalent cyclic carbonate monomer, comprising reacting an epoxy precursor with CO₂ in the presence of a catalyst, wherein the catalyst is the combination of Ti(OiPr)₄ and TPAB or the combination of Ti(OiPr)4 and tetrabutylammonium bromide.

Item 24: The process of Item 23, wherein the multivalent cyclic carbonate monomer is DGEBA-CO₂.

Item 25: The process of Item 23, wherein the epoxy precursor is diglycidyl ether of bisphenol A (DGEBA).

### EXAMPLES

The following examples are provided to illustrate specific embodiments of the current disclosure and to demonstrate the features and advantages of the embodiments but are not intended to limit the scope thereof. Instead, the examples guide one of ordinary skill in the art in understanding and applying the inventive concepts of the disclosure.

### Example 1

Synthesis of DGEBA-CO₂ (FIG. 3A): To a vial was added a solution of DGEBA (20 g, 58.5 mmol), Ti(OiPr)₄ (166 mg, 0.58 mmol), and TPAB (154 mg, 0.58 mmol) in DMF (10 mL). Dry ice (20 g) was added to a pressure vessel, and the above vial was placed on top of the dry ice. The pressure vessel was sealed and heated at 100° C. in an oil bath. The pressure gauge on the vessel indicated the inside pressure was around 400-700 Psi. After heating at 100° C. for 6-10 h, the reaction was cooled to room temperature and the pressure inside was released. The crude product NMR shows clean DGEBA-CO₂ product with a small amount of TPAB. The reaction mixture was dissolved in hot DMF (~ 30 mL) and the product was recrystallized. The white solid was filtered and dried in a 70° C. oven to provide DGEBA-CO₂ (18 - 22 g, 74-89%): ¹H NMR (300 MHz, Chloroform-d) δ 7.20 - 7.11 (m, 4H), 6.86 - 6.76 (m, 4H), 5.02 (dddd, J = 8.1, 5.9, 4.3, 3.6 Hz, 2H), 4.67 - 4.48 (m, 4H), 4.29 - 4.06 (m, 4H), 1.64 (s, 6H). ¹H-NMR spectrum was obtained on a Burker-300 Ultrashield NMR instrument.

### Example 2

Synthesis of a PHU (FIG. 3B): DGEBA-CO₂ (1.0 g) and TREN (228 mg) were mixed in DMF (5 mL). The clear solution was poured into a petri dish and heated at 100° C. for 2 h. A PHU film was formed, which was heat pressed at 100° C. for another 3-4 h. The Young’s modulus was 2.6 GPa, stress at break ~73 MPa, elongation at break about 3-4% (Table 1, PHU).

TABLE 1

Summary of mechanical properties of PHU, PHU-PI, PHU-PI-epoxy polymer films.

| Vitrimers | DGEBA-CO₂ Equiv. | DGEBA Equiv. | TPA Equiv. | DETA Equiv. | Preamine Equiv. | TREN Equiv. | Tensile Modulus GPa |
|---|---|---|---|---|---|---|---|
| PHU-1 | 1.00 | | | | | 0.33 | 2.6 |
| PHU-2 | | | | | 0.3 | 0.47 | 2.7 |
| PHU-3 | 1.00 | | | 0.30 | | 0.47 | 4.0 |
| PHU-PI-1 | 0.50 | | 0.50 | 0.20 | | 0.53 | 3.0 |
| PHU-PI-3 | 0.50 | | 0.50 | 0.30 | | 0.47 | 2.8 |
| PHU-PI-2 | 0.75 | | 0.25 | 0.20 | | 0.53 | 3.4 |
| PHU-PI-4 | 0.90 | | 0.10 | 0.30 | | 0.47 | 3.6 |
| PHU-PI-5 | 1.00 | | 0.10 | 0.30 | | 0.47 | 4.9 |
| PHU-PI-epoxy | 0.70 | 0.30 | 0.10 | 0.30 | | 0.47 | 5.2 |

### Example 3

Synthesis of PHU-PI: DGEBA-CO₂ (2.00 g, 4.67 mmol) and TPA (63 mg, 0.477 mmol) were dissolved in DMF (5 mL). To the homogeneous solution were added DETA (144 mg, 1.40 mmol) followed by TREN (319 mg, 2.18 mmol) dropwise with stirring. The yellow-orange solution was poured into a PTFE petri dish and heated at 120° C. for 18 h to form a yellow film (2.52 g, 100%). The Young’s modulus was 4.9 GPa, stress at break ~108 MPa, elongation at break about 3-4% (FIG. 3C, Table 1, PHU-PI-5)

### Example 4

Synthesis of a PHU-PI-epoxy: DGEBA-CO₂ (1.50 g, 3.50 mmol), DGEBA (511 mg, 1.50 mmol), and TPA (67 mg, 0.50 mmol) were dissolved in DMF (10 mL). To the homogeneous solution were added DETA (155 mg, 1.50 mmol) followed by TREN (341 mg, 2.33 mmol) dropwise with stirring. The yellow-orange solution was poured into a PTFE petri dish and heated at 120° C. for 18 h to form a yellow film (2.51 g, 98%). The Young’s modulus was 5.2 GPa, (Table 1, PHU-PI-epoxy)

### Example 5

Recycling of a PHU polymer (FIG. 4): A piece of PHU polymer film (200 mg) was soaked in a suspension of K₂CO₃ (100 mg) in ethanol (10 mL). The mixture was heated at 100° C. for 10 h with agitation. The PHU film was completely dissolved. The mixture was filtered, and the filtrate was concentrated to provide 40H-DGEBA and 3Cbm-TREN.

### Example 6

Preparation of a CFRC sheet from woven carbon fibers (FIG. 5A): A piece of woven carbon fiber (1.17 g, FibreGlast, 3 k carbon fiber) was soaked in a solution DGEBA-CO₂ (500 mg), TREN (114 mg) in DMF (3 mL). The mixture was heated at 100° C. for 2 h. The formed film was heat-pressed at 100° C. for another 3-4 h to obtain the composite sheet. The tensile properties of the prepared composite sheet were measured through uniaxial tensile tests. The Young’s modulus was 50-60 GPa, stress at break 600-700 MPa, elongation at break about 1-2%.

### Example 7

Recycling of a CFRC (FIG. 5C): A piece of CFRC sheet (400 mg) was soaked in a suspension of K₂CO₃ (100 mg) in ethanol (10 mL). The mixture was heated at 100° C. for 10 h with agitation. The PHU matrix was completely dissolved. The carbon fiber was removed from the solution and dried for reuse. The rest of the mixture was filtered, and the filtrate was concentrated to provide 4OH-DGEBA and 3Cbm-TREN.

### Example 8

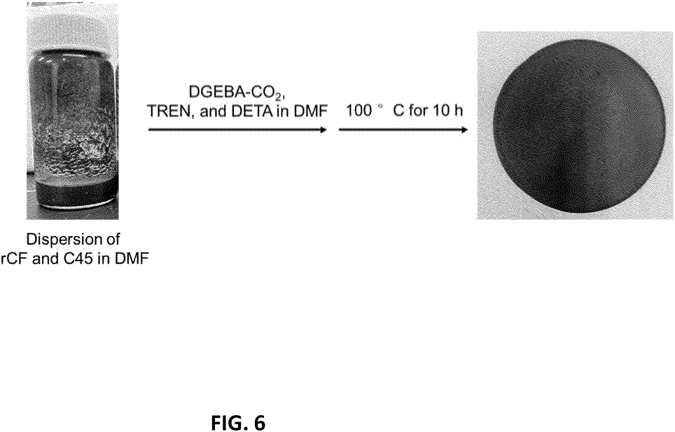

Preparation of a conductive CFRC sheet from recycled milled carbon fibers (FIG. 6): A mixture of milled recycled carbon fiber (rCF, 600 mg, Zoltek, recycled milled fiber, 150 µm length) and carbon black Super C45 (25 mg) in DMF (3 mL) were sonicated in a probe sonicator (Sonics, VCX 750) for 20 min. In another vial, DGEBA-CO₂ (500 mg), TREN (80 mg), and DETA (36 mg) were mixed in DMF (2 mL). The two mixtures were then mixed and poured into a petri dish (diameter 6 cm). The mixture was heated at 100° C. for 10 h. A black sheet of the composite was formed. The conductivity of the composite was measured using 4-point probe and found to be 1850-2630 s/m. The tensile properties of the prepared PHU polymer were measured from uniaxial tensile tests. The Young’s modulus was 13.5 GPa, stress at break ~70 MPa, elongation at break about 0.8%.

We claim:

1. A composition comprising a polyhydroxyurethane (PHU) polymer prepared from a reaction system comprising a multivalent cyclic carbonate monomer and a multivalent amine monomer.

2. The composition of claim 1, wherein the molar equivalent ratio of total cyclic carbonate groups and total amine groups in the reaction system is about 1:1.

3. The composition of claim 1, further comprising at least one type of fiber.

4. The composition of claim 3, wherein the at least one type of fiber is carbon fiber.

5. A composite material comprising the composition of claim 3, wherein said composite material is prepared by curing the composition of claim 3.

6. The composition of claim 1, wherein said polyhydroxyurethane polymer is not malleable in dry form at room temperature and said polyhydroxyurethane polymer becomes malleable when said it is in contact with a catalyst or when it is heated to a temperature between 70° C. and 250° C.

7. A composition comprising a polyhydroxyurethane (PHU) and polyimine (PI) hybrid polymer (PHU-PI) prepared from a reaction system comprising a multivalent cyclic carbonate monomer, a multivalent aldehyde monomer, and a multivalent amine monomer.

8. The composition of claim 7, wherein the molar equivalent ratio between total cyclic carbonate groups and aldehyde groups and total amine groups in the reaction system is about 1:1 ((cyclic carbonate + aldehyde):amine ~ 1:1).

9. The composition of claim 7, further comprising at least one type of fiber.

10. The composition of claim 9, wherein the at least one type of fiber is carbon fiber.

11. A composite material comprising the composition of claim 9, wherein said composite material is prepared by curing the composition of claim 9.

12. The composition of claim 7, wherein said polyhydroxyurethane (PHU) and polyimine (PI) hybrid polymer (PHU-PI) is not malleable in dry form at room temperature and said PHU-PI hybrid polymer becomes malleable when said it is in contact with a catalyst or when it is heated to a temperature between 70° C. and 250° C.

13. A composition comprising a polyhydroxyurethane (PHU), polyimine (PI), and epoxy resin hybrid polymer (PHU-PI-epoxy) prepared from a reaction system comprising a multivalent cyclic carbonate monomer, a multivalent aldehyde monomer, a multivalent epoxide monomer, and a multivalent amine monomer.

14. The composition of claim 13, wherein the molar equivalent ratios between total cyclic carbonate groups, plus aldehyde groups, plus epoxide and total amine groups in the reaction system are about 1:1 ((cyclic carbonate+aldehyde+epoxide):amine ~ 1:1).

15. The composition of claim 13, further comprising at least one type of fiber.

16. The composition of claim 15, wherein the at least one type of fiber is carbon fiber.

17. A composite material comprising the composition of claim 15, wherein said composite material is prepared by curing the composition of claim 15.

18. The composition of claim 13, wherein said polyhydroxyurethane (PHU), polyimine (PI), and epoxy resin hybrid polymer (PHU-PI-epoxy) is not malleable in dry form at room temperature and said PHU-PI-epoxy hybrid polymer becomes malleable when said it is in contact with a catalyst or when it is heated to a temperature between 70° C. and 250° C.

19. A method of reshaping the composition of claim 4, comprising
a) heating a sheet form of the composite material to an elevated temperature,
b) pressing and material from step (a), and
c) cooling the material from step (b) to room temperature.

20. A method of recycling the composition of claim 1, comprising
a) contacting the polyhydroxyurethane polymer with a liquid to form a soluble material, and
b) converting the soluble material into a dry form of the polyhydroxyurethane polymer, or the pure form of small molecules.

21. A method of recycling the composition of claim 4, comprising
a) contacting the composition with a liquid to form a soluble material,
b) separating at least one fiber from the soluble material, and
c) converting the soluble material into a dry form of the polyhydroxyurethane polymer,
or the pure form of small molecules.

22. The composition of claim 5, wherein the weight ratio between the carbon fiber and the polymer is 10:90 to 70:30.

23. A process of preparing a multivalent cyclic carbonate monomer, comprising reacting an epoxy precursor with CO₂ in the presence of a catalyst, wherein the catalyst is the combination of Ti(OiPr)₄ and TPAB or the combination of Ti(OiPr)4 and tetrabutylammonium bromide.

24. The process of claim 23, wherein the multivalent cyclic carbonate monomer is DGEBA-CO₂.

25. The process of claim 23, wherein the epoxy precursor is diglycidyl ether of bisphenol A (DGEBA).
